(19) United States
(12) Patent Application Publication
(10) Pub. No.: US 2013/0300739 A1
(43) Pub. Date: Nov. 14, 2013

(54) STEREOSCOPIC APPAREL TRY-ON METHOD AND DEVICE

(71) Applicant: MSTAR SEMICONDUCTOR, INC., Hsinchu County (TW)

(72) Inventor: Jin-Hua Fan, Hsinchu County (TW)

(73) Assignee: MStar Semiconductor, Inc., Hsinchu County (TW)

(21) Appl. No.: 13/705,256

(22) Filed: Dec. 5, 2012

(30) Foreign Application Priority Data
May 9, 2012 (CN) 201210142087.7

(51) Int. Cl. G06T 17/10

(52) U.S. Cl. CPC G06T 17/10
USPC 345/420

(57) ABSTRACT

A stereoscopic apparel try-on method is provided. The method includes steps of: obtaining a pair of human body images of a user taken at different visual angles; constructing a human body stereoscopic model according to the pair of human body images; querying an apparel database for a stereoscopic apparel model having a size matching a size of the human body stereoscopic model; and generating a stereoscopic apparel try-on result image according to the human body stereoscopic model and the stereoscopic apparel model.

This application claims the benefit of People's Republic of China Patent application Serial No. 201210142087.7, filed May 9, 2012, the subject matter of which is incorporated herein by reference.

### BACKGROUND OF THE INVENTION

1. Field of the Invention

The invention relates in general to a display technique, and more particularly to a stereoscopic apparel try-on method and device.

2. Description of the Related Art

As electronic commerce continues to prevail, online shopping offers features of being convenient, time-saving, and money-saving, much enjoyed by the public. For a vast number of consumers, online shopping is considered an indispensable part of daily life of the modern lifestyle.

When purchasing apparel online, it is frequent that a consumer faces a possible risk of an unsatisfactory final look after actually putting on the apparel because the apparel cannot be physically tried on in advance of purchase and reception. Although some websites offer a “virtual dressing room”, functions associated with the virtual dressing room display only apparel try-on results made up by putting together a user face image and simple two-dimensional (2D) images. However, these apparel try-on results lack crucial details such as whether the apparel perfectly fits the user or whether the apparel is easily wrinkled. Consequently, in current online apparel shopping, returns and exchanges resulted by poor-fitting are rather high, implying that an effective rate of online apparel shopping is in fact quite low.

### SUMMARY OF THE INVENTION

The disclosure is directed to a stereoscopic apparel try-on method and device for solving the incapability of showing a true apparel try-on result to a consumer during a process of apparel online shopping in current techniques.

The disclosure provides a stereoscopic apparel try-on method. The method includes steps of: obtaining a pair of human body images of a user taken at different visual angles; constructing a human body stereoscopic model according to the pair of human body images; querying an apparel database for a stereoscopic apparel model having a size matching a size of the human body stereoscopic model; and generating a stereoscopic apparel try-on result image according to the human body stereoscopic model and the stereoscopic apparel model.

The disclosure further provides a stereoscopic apparel try-on device. The stereoscopic apparel try-on device includes: an image obtaining unit, for obtaining a pair of human body images of a user taken at different visual angles; a human body stereoscopic model constructing unit, for constructing a human body stereoscopic model according to the pair of human body images; a matching unit, for querying an apparel database for a stereoscopic apparel model having a size matching a size of the human body stereoscopic model; and a combining unit, for generating a stereoscopic apparel try-on result image according to the human body stereoscopic model and the stereoscopic apparel model.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a process of a stereoscopic apparel try-on method according to an embodiment of the disclosure.

FIG. 2 is a process for constructing a human body stereoscopic model according to a pair of human body images in the stereoscopic apparel try-on method of FIG. 1.

FIG. 3 is a schematic diagram illustrating relations of spatial coordinates and image coordinates of a human body characteristic point according to an embodiment of the disclosure.

FIG. 4 is a schematic diagram illustrating relations of spatial coordinates and image coordinates of a human body characteristic point according to another embodiment of the disclosure.

FIG. 5 is a schematic diagram of a stereoscopic apparel try-on device according to an embodiment of the disclosure.

FIG. 6 is a schematic diagram of a human body stereoscopic model constructing unit according to an embodiment of the disclosure.

### DETAILED DESCRIPTION OF THE INVENTION

Details of embodiments of the disclosure are described with reference to the diagrams.

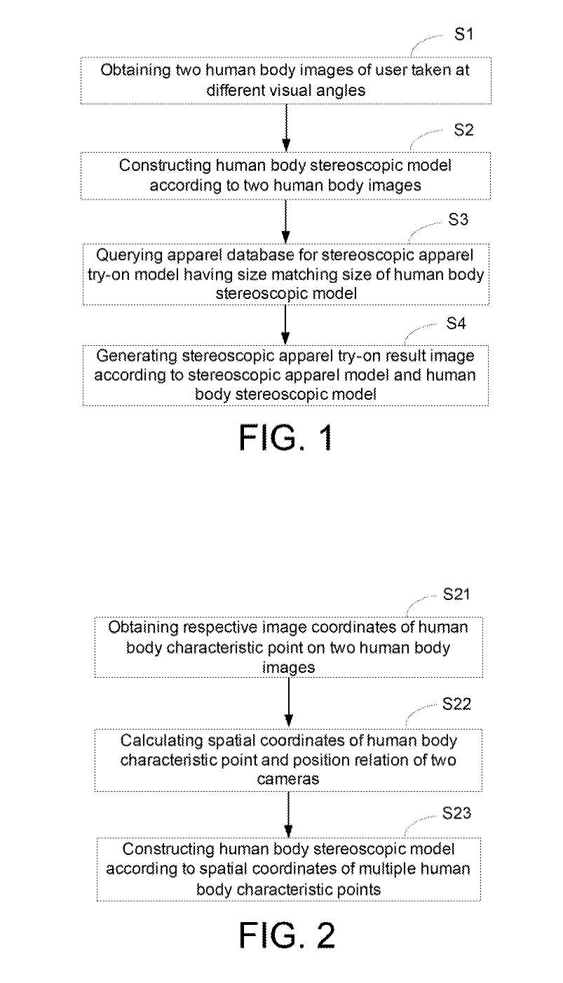

FIG. 1 shows a process of a stereoscopic apparel try-on method according to an embodiment of the disclosure.

In Step S1, a pair of human body images of a user taken at different visual angles are obtained.

In Step S2, a human body stereoscopic model is constructed according to the pair of human body images.

In Step S3, an apparel database is queried for a stereoscopic apparel model having a size matching a size of the human body stereoscopic model.

In Step S4, a stereoscopic apparel try-on result image is generated according to the stereoscopic apparel model and the human body stereoscopic model.

Further, in Step S1, an image input apparatus may be utilized for obtaining the human body images. For example, a pair of human body images of the user are taken by two cameras spaced by a predetermined distance. For example, the cameras in this step are digital cameras such as high-resolution USB CCD cameras. It is easily appreciated by a person having ordinary skill in the art that, this step further includes obtaining a pair of human body images taken at different visual angles pre-captured through wired or wireless means. Further, human body images may be captured automatically, using automated video or image capture, while implementing multiple image input apparatuses combined with selective computer processing.

FIG. 2 shows a detailed flowchart of Step S2 of the stereoscopic apparel try-on method according to an embodiment of the disclosure.

In Step S21, image coordinates of a human characteristic point on the pair of human body images point are respectively obtained.

In Step S22, spatial coordinates of the human characteristic point are calculated according to the image coordinates and a position relation of the two cameras.

In Step S23, the human body stereoscopic model is constructed according to the spatial coordinates of multiple human body characteristic points.

Further, in Step S21, the pair of obtained human body images are filtered to identify certain human body characteristic points. The filtering process may be implemented according to differences in colors and brightness between a background and the human body characteristic points.

The human body characteristic points are such as human body sizes (e.g., a height, arm length, or waist measure) including a crown of a head, a sole of a foot, and fingers of left and right hands. Different image coordinates corresponding to the same characteristic points on the pair of human body images are then respectively obtained.

In Step S22, according to the difference in image coordinates of the same characteristic point and the position relation of the two cameras, the spatial coordinates of the human body characteristic points relative to the cameras or another reference object may be calculated by trigonometry or other calculations based on the lens imaging principle.

Referring to FIG. 3, taking a crown of a human head for example, assume that the crown of the head and the two cameras are located on a same Y plane. A center 0 is regarded as origins of X and Y coordinates, and is a center of a connecting line between centers of two lenses of the two cameras. Based on trigonometry, the spatial coordinates of the crown of the head are deduced by the equations below:

z0=d=f*b/(X2+X1);

x0=(X2−X1)*d/f=(X2−X1)*b/(X2+X1);

where f is a distance between the centers of the lenses of the two cameras and respective image planes, b is a distance between the centers of the lenses of the two cameras, and X1 and X2 are respectively image coordinates of the crown of the head on the two image planes.

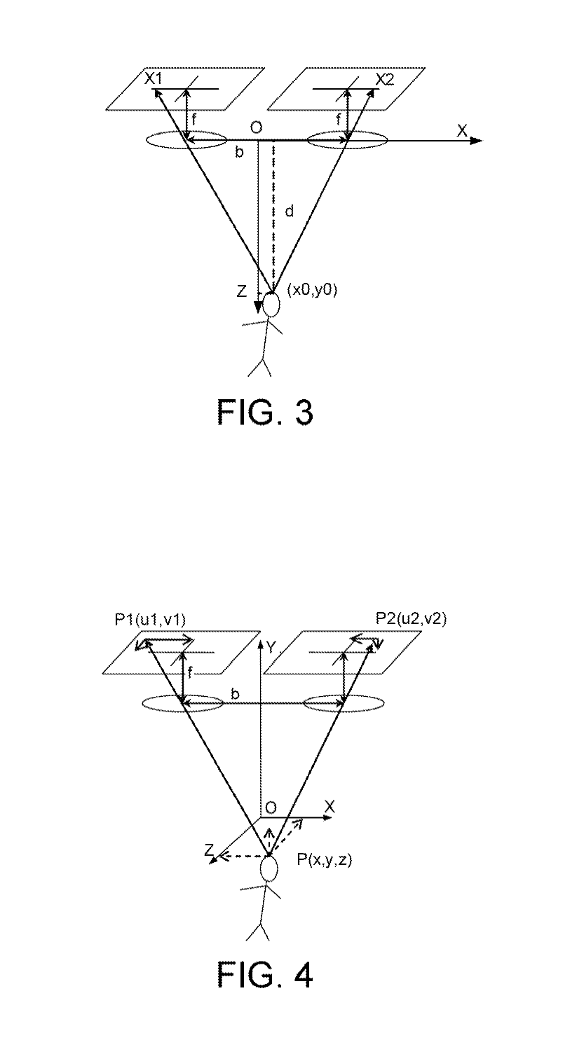

Referring to FIG. 4, when the crown of the head and the two cameras are not located on the same plane, according to the lens imaging principle, the spatial coordinates of the crown of the head may be calculated through the image coordinates of the human body characteristic point and the position relation of the two cameras. More specifically, in FIG. 4, in an X, Y, and Z coordinate system with a point O as an origin, the coordinates of the crown of the head p are calculated. According to trigonometry, corresponding x, y, and z coordinates are respectively calculated through a distance b between the two USB cameras, image coordinates p1(u1, v1) and p2(u2, v2) of the point p on the two image planes, and a distance f between the lenses and the image plane.

Further, in Step S23, by considering differences between spatial coordinates of a large number of human body characteristic points, human body sizes such as the height, arm length, and waist measure can be calculated for constructing the corresponding human body stereoscopic model. In the disclosure, the human body stereoscopic model is constructed by a binocular stereo vision 3D construction technique implemented by a given algorithm or set of algorithms. Some of are indicated in the following list of algorithms, for example:
1) Marr-Poggio-Grimson algorithm;
2) R. Nevatia-G. Medioni algorithm;
3) R. Y. Wong algorithm;
4) K. Price-R. Reddy algorithm;
5) C. S. Clark-A. L. Luck-C. A. McNary algorithm;
6) K. E. Price algorithm;
7) R. Horaud-T. Skorads algorithm; and
8) W. Hoff-N. Ahuja algorithm.

In Step S3, corresponding sizes of various stereoscopic apparel models in the apparel database are obtained, and a size matching calculation is performed with respect to the human body stereoscopic model to determine whether the size of the accessed stereoscopic apparel model matches the size of the human body stereoscopic model. When the size of the accessed stereoscopic apparel model matches the size of the human body stereoscopic model, the stereoscopic apparel model with the matching size is obtained. Differences in parts including a collar, sleeves, a waistline, and a bottom between the stereoscopic apparel model and the human body stereoscopic model are calculated to obtain calculation results.

Further, in Step S3, an apparel database at a remote server may be obtained. The apparel database stores stereoscopic apparel models in difference sizes to ensure that data is in real-time updated. For examples, approaches for obtaining the apparel database may include wired and wireless means including RJ45, RS232, Wifi, Bluetooth, Zigbee, infrared, and 3G.

In Step S4, a stereoscopic model is generated according to the calculation results obtained in Step S3, and a final stereoscopic try-on result image is generated after performing 3D rendering. A real head image of the user may further be added to the stereoscopic try-on result image to more realistically display the apparel try-on result.

The stereoscopic try-on result image may be a single image that is displayed in a 2D form using a display system. Further, the stereoscopic try-on result image may also be a 3D image having left-eye and right-eye images and displayed in a 3D form by a corresponding display system.

The steps of above stereoscopic apparel try-on method may be performed at one terminal, or may be performed at different terminals through cloud computing.

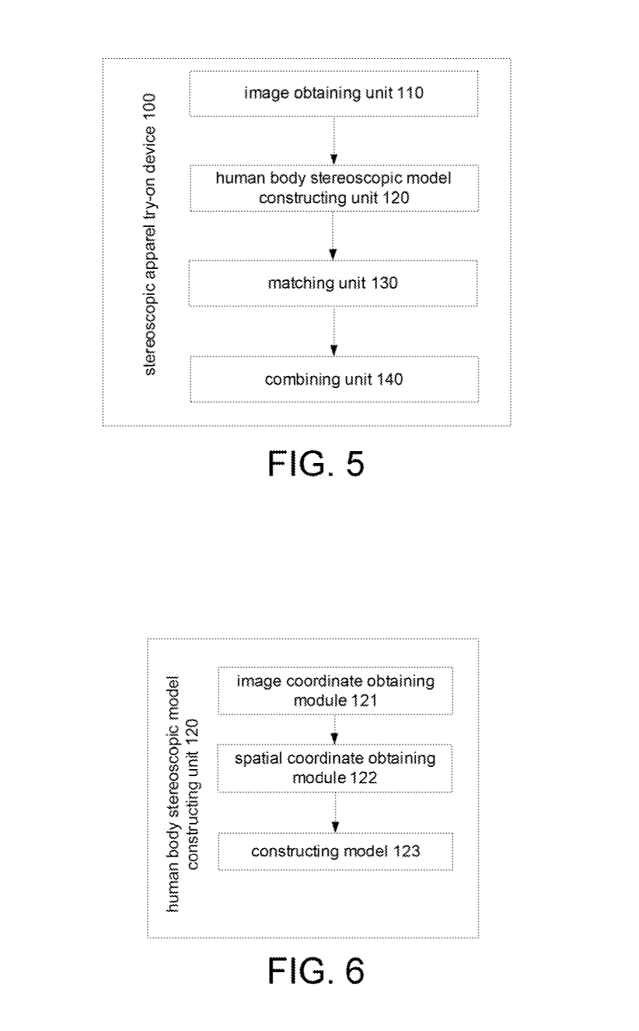

FIG. 5 shows a schematic diagram of a stereoscopic apparel try-on device according to an embodiment of the disclosure. Referring to FIG. 5, a stereoscopic apparel try-on device 100 includes an image obtaining unit 110, a human body stereoscopic model constructing unit 120, a matching unit 130, and a combining unit 140.

The image obtaining unit 110 obtains a pair of human body images of a user taken at different visual angles. In this embodiment, the image obtaining unit 110 may includes two cameras spaced by a predetermined distance, such that the pair of human body images of the user taken at different visual angles of the user standing in front of the stereoscopic apparel try-on device 100 can be obtained by the two cameras.

Further, the image obtaining unit 110 may be any appropriate hardware or software capable of maintaining communication with an external apparatus, so as to obtain a pair of pre-captured human body images taken at different visual angles from the external apparatus.

The human body stereoscopic constructing unit 120 constructs a human body stereoscopic model according to the pair of human body images. In this embodiment, the human body stereoscopic constructing unit 120 is an image calculation processing module based on a stereo vision 3D construction technique, and is capable of calculating various human body sizes according to a pair of human body images taken at different visual angles to construct a corresponding human body stereoscopic model.

FIG. 6 shows a schematic diagram of a human body stereoscopic model constructing unit according to an embodiment of the disclosure. As shown in FIG. 6, the human body stereoscopic model constructing unit 120 includes an image coordinate obtaining module 121, a spatial coordinate obtaining module 122, and a constructing module 123. The image coordinate obtaining module 121 obtains respective image coordinates of a human body characteristic point on the pair of human body images. The spatial coordinate obtaining module 122 calculates spatial coordinates of the human body characteristic point according to the image coordinates and a position relation of the two cameras. The constructing module 123 constructs the human body stereoscopic model according to the spatial coordinates of multiple human body characteristic points. Operation details of the above modules are as previously described, and shall be omitted herein for the sake of brevity.

The matching unit 130 queries an apparel database for a stereoscopic apparel model having a size matching a size of the human body stereoscopic model. From a remote server, the matching unit 130 may obtain an apparel database that contains stereoscopic apparel models in different sizes.

The combining unit 140 generates a stereoscopic apparel try-on result image according to the human body stereoscopic model and the stereoscopic apparel model. The combining unit 140 may further add a real head image of the user to the stereoscopic apparel try-on result image.

In this embodiment, the stereoscopic apparel try-on device 100 may be a smart television. A current smart television system has evolved from a simple watch function to sophisticated functions supporting digitalization, networking and intelligence further combined with partial functions of a computer. More specifically, compared to a conventional computer, apart from webpage browsing, video calls and online shopping, a smart television system in addition offer advantages of being large-size and high-definition as well as capable of 3D display. Therefore, the stereoscopic apparel try-on device 100 may further correspondingly include a television signal transceiving module, a network communication module, a human-machine exchange module, and a display module.

The television transceiving module is a common television signal receiving/processing module for implementing the television program watch function. The network communication module is a network interface provided in the smart television system. Through the network communication module, a user may access the Internet for online shopping, and stereoscopic apparel models in difference sizes may also be downloaded from an apparel database of an online shopping website to a local end. The human-machine exchange module is a common television central processing control unit for controlling system functions of system hardware and display processing of the human-machine exchange interface. The display module is a television screen for displaying television images and stereoscopic apparel try-on result images on a high-definition large screen.

Compared to a conventional solution, the stereoscopic apparel try-on method and device according to embodiments of the disclosure is capable of presenting an apparel try-on result in a realistic stereoscopic form with a convenient and simple manner, thereby significantly enhancing user experiences as well as increasing apparel shopping efficiency of consumers.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stereoscopic apparel try-on method, comprising:
obtaining a pair of human body images of a user taken at different visual angles;
constructing a human body stereoscopic model according to the human body images;
querying an apparel database for a stereoscopic apparel model having a size matching a size of the human body stereoscopic model; and
generating a stereoscopic apparel try-on result image according to the human body stereoscopic model and the stereoscopic apparel model.

2. The method according to claim 1, wherein the step of obtaining the pair of human body images of the user taken at different visual angles comprises:
obtaining the pair of human body images by two cameras spaced by a predetermined distance.

3. The method according to claim 2, wherein the step of constructing the human body stereoscopic model according to the pair of human body images comprises:
obtaining respective image coordinates of a human body characteristic point on the pair of human body images;
calculating spatial coordinates of the human body characteristic point according to the image coordinates and a position relation of the two cameras; and
constructing the human body stereoscopic model according to the spatial coordinates of a plurality of the human body characteristic points.

4. The method according to claim 1, wherein the step of querying the apparel database for the stereoscopic apparel model having the size matching the size of the human body stereoscopic model comprises:
obtaining the apparel database storing stereoscopic apparel models in difference sizes from a remote server.

5. The method according to claim 1, wherein the step of generating the stereoscopic apparel try-on result image according to the human body stereoscopic model and the stereoscopic apparel mode comprises:
adding a real head image of the user to the stereoscopic apparel try-on result image.

6. A stereoscopic apparel try-on device, comprising:
an image obtaining unit, for obtaining a pair of human body images of a user taken at different visual angles;
a human body stereoscopic model constructing unit, for constructing a human body stereoscopic model according to the human body images;
a matching unit, for querying an apparel database for a stereoscopic apparel model having a size matching a size of the human body stereoscopic model; and
a combining unit, for generating a stereoscopic apparel try-on result image according to the human body stereoscopic model and the stereoscopic apparel model.

7. The device according to claim 6, wherein the image obtaining unit comprises two cameras spaced by a predetermined distance.

8. The device according to claim 7, wherein the human body stereoscopic model constructing unit comprises:
an image coordinate obtaining module, for obtaining respective image coordinates of a human body characteristic point on the pair of human body images;
a spatial coordinate obtaining module, for calculating spatial coordinates of the human body characteristic point according to the image coordinates and a position relation of the two cameras; and
a constructing module, for constructing the human body stereoscopic model according to the spatial coordinates of a plurality of the human body characteristic points.

9. The device according to claim 6, wherein the matching unit obtains the apparel database storing stereoscopic apparel models in difference sizes from a remote server.

10. The device according to claim 6, wherein the combining unit adds a real head image of the user to the stereoscopic apparel try-on result image.
